(19) United States
(12) Patent Application Publication
(10) Pub. No.: US 2025/0379745 A1
(43) Pub. Date: Dec. 11, 2025

(54) METHODS, SYSTEMS, AND DEVICES FOR AUTHENTICATING STREAMING AND STORAGE OF DATA ORIGINATING FROM A TRUSTED EXECUTION ENVIRONMENT

(71) Applicant: JPMorgan Chase Bank, N.A., New York, NY (US)

(72) Inventor: Mark F. Novak, Newcastle, WA (US)

(73) Assignee: JPMorgan Chase Bank, N.A., New York, NY (US)

(21) Appl. No.: 18/737,137

(22) Filed: Jun. 7, 2024

(51) Int. Cl. H04L 9/32; H04L 9/08

(52) U.S. Cl. CPC H04L 9/3247; H04L 9/0822

(57) ABSTRACT

Aspects of the subject disclosure may include, for example, capturing data by a first communication device associated with a data producer, signing the data with a signing key resulting in signed data, encrypting the signed data according to an encryption key resulting in encrypted signed data, and storing the encrypted data in a storage device. Further, the embodiments can include receiving, over a communication network, a request associated with the data from a second communication device associated with a data consumer, and providing, over the communication network, the encrypted signed data to the second communication device. The second communication device receives the encrypted signed data, decrypts the encrypted signed data according to a decryption key resulting in the decrypted signed data, and authenticates the decrypted signed data. Other embodiments are disclosed.

### FIELD OF THE DISCLOSURE

The subject disclosure relates to methods, systems, and devices for authenticating streaming and storage of data originating from a trusted execution environment (TEE).

### BACKGROUND

In many instances where computing is performed within a TEE (e.g., enclaves, confidential virtual machines, Internet of Things (IoT) devices, etc.), the TEE can generate data and store this data for later access by an outside party. When consuming this data at a later time, the outside party may need to be convinced of the generated data's provenance (i.e., determination of authenticity). In instances of real-time data consumption, this problem can be solved via remote attestation of the originating/generating TEE. However, current attestation mechanisms are not designed to work with determining a data's provenance across time spans (e.g., accessed at a later time by the outside party).

### SUMMARY OF THE DISCLOSURE

The subject disclosure describes, among other things, illustrative embodiments capturing data by a first communication device associated with a data producer, signing the data with a signing key resulting in signed data, encrypting the signed data according to an encryption key resulting in encrypted data, and storing the encrypted data in a storage device. Further embodiments can include receiving, over a communication network, a request associated with the data from a second communication device associated with a data consumer, and providing, over the communication network, the encrypted signed data to the second communication device. The second communication device receives the encrypted signed data, the second communication device decrypts the encrypted signed data according to a decryption key resulting in decrypted signed data, and the second communication device authenticates the decrypted signed data. Other embodiments are described in the subject disclosure.

One or more aspects of the subject disclosure include a device, comprising a processing system including a processor, a memory that stores executable instructions that, when executed by the processing system, facilitate performance of operations. The operations can comprise capturing data by a first communication device associated with a data producer, signing the data with a signing key resulting in signed data, encrypting the signed data according to an encryption key resulting in encrypted signed data, and storing the encrypted data in a storage device. Further operations can comprise receiving, over a communication network, a request associated with the data from a second communication device associated with a data consumer, and providing, over the communication network, the encrypted signed data to the second communication device. The second communication device receives the encrypted signed data, the second communication device decrypts the encrypted signed data according to a decryption key resulting in the decrypted signed data, and the second communication device authenticates the decrypted signed data. In further embodiments, authenticating data using a signing key involves establishing trust in that signing key, which is a function of how the trust in the signing key itself is established. Typically, it is done by verifying the certificate associated with the signing key, but it could also be done by validating a quote (a confidential computing term of art) over the generated signing key. The quote is generated by the data producer in such embodiments.

One or more aspects of the subject disclosure include a non-transitory machine-readable medium, comprising executable instructions that, when executed by a processing system including a processor, facilitate performance of operations. The operations can comprise capturing data by a first communication device associated with a data producer, obtaining a signing key, signing the data with the signing key resulting in signed data, obtaining an encryption key, encrypting the signed data according to an encryption key resulting in encrypted signed data, and storing the encrypted data in a storage device. Further operations can comprise receiving, over a communication network, a request associated with the data from a second communication device associated with a data consumer, and providing, over the communication network, the encrypted signed data to the second communication device. The second communication device receives the encrypted signed data, the second communication device decrypts the encrypted signed data according to a decryption key resulting in the decrypted signed data, and the second communication device authenticates the decrypted signed data.

One or more aspects of the subject disclosure include a method. The method can comprise obtaining, by a processing system including a processor, data from a first communication device associated with a data producer, generating, by the processing system, a signing key, signing, by the processing system, the data with the signing key resulting in signed data, generating, by the processing system, an encryption key, encrypting, by the processing system, the signed data according to the encryption key resulting in encrypted signed data, and storing, by the processing system, the encrypted data in a storage device. Further, the method can comprise receiving, by the processing system, over a communication network, a request associated with the data from a second communication device associated with a data consumer, and providing, by the processing system, over the communication network, the encrypted signed data to the second communication device. The second communication device receives the encrypted signed data, the second communication device decrypts the encrypted signed data according to a decryption key resulting in the decrypted signed data, and the second communication device authenticates the decrypted signed data.

### BRIEF DESCRIPTION OF THE DRAWINGS

Reference will now be made to the accompanying drawings, which are not necessarily drawn to scale, and wherein:

FIG. 1 and FIG. 2 are block diagrams illustrating example, non-limiting embodiments of a system functioning in accordance with various aspects described herein.

FIG. 3 depicts an illustrative embodiment of a method in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

### DETAILED DESCRIPTION

Aspects of the disclosure include a communication device (e.g., a surveillance camera) associated with a data producer capturing data to be accessed not in real-time but at some time in the future. Due to the prevalence of malicious actors, the data is authenticated with a signing key (e.g., signed) and then encrypted prior to storing the data. Subsequent to a request for the data from a communication device associated with a data consumer, the encrypted signed data is provided. Upon receipt, the encrypted signed data is decrypted and authenticated thereby confirming the veracity of the data for the data consumer.

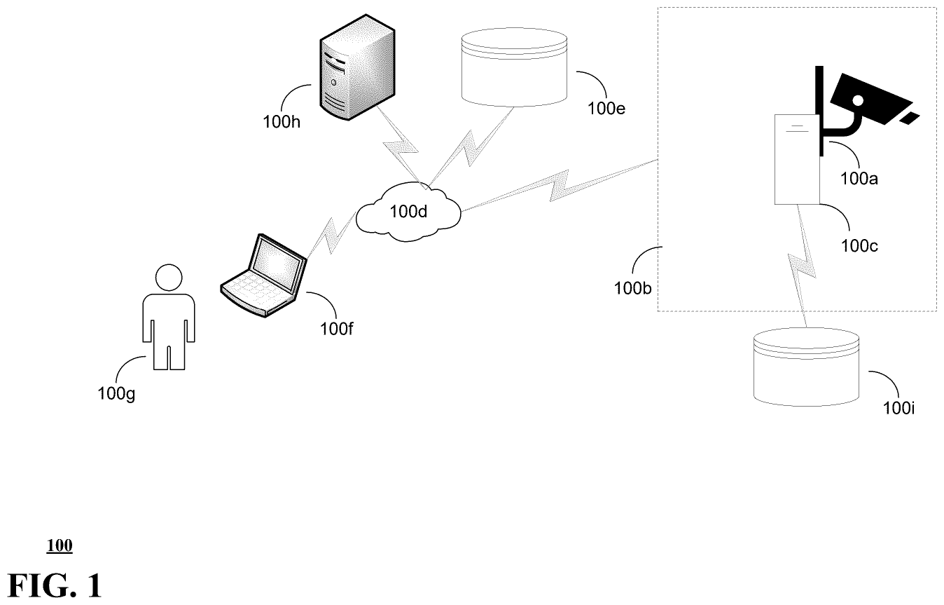

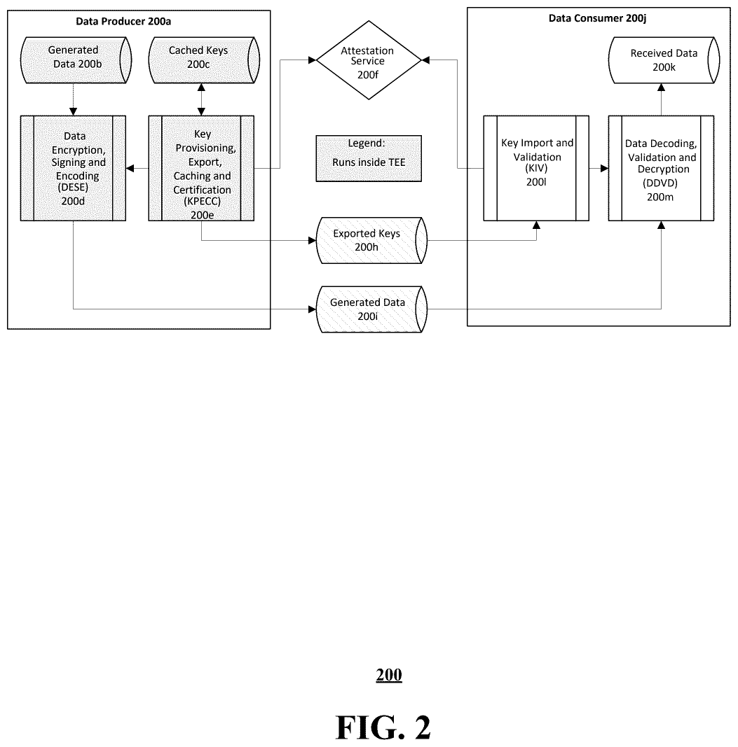

FIG. 1 and FIG. 2 are block diagrams illustrating example, non-limiting embodiments of a system functioning in accordance with various aspects described herein. Referring to FIG. 1, in one or more embodiments, a system 100 can include a security (e.g., surveillance) camera 100a that is communicatively coupled to a central processing unit (CPU) 100c as part of data producer computer system 100b. In some embodiments, the data producer computer system 100b can be a trusted execution environment (TEE). Thus, features of a TEE described herein can also be applied generally to a data producer computer system 100b. The system 100b can also include a storage device 100i (e.g., memory, database, etc.) that can store data (after being encrypted by CPU 100c) captured by security camera 100a. Further, a communication device 100f is communicatively coupled to CPU 100c over communication network 100d. A user 100g can be associated with communication device 100f. In addition, server 100h can be communicatively coupled to CPU 100c, key vault 100e, and communication device 100f over communication network 100d.

In one or more embodiments, communication network 100d can comprise one or more wireless communication networks, one or more wired communication networks, or a combination thereof. Further, communication device 100f can comprise a mobile device, mobile phone, tablet computer, laptop computer, desktop computer, or any other computing device. In addition, server 100h can comprise one or more servers located in one premises or spanning multiple premises, one or more virtual servers located in one premises or spanning multiple premises, one or more cloud servers, or a combination thereof. Although system 100 illustrates that CPU 100c is communicatively coupled to security camera 100a, in additional embodiments, CPU 100c can be communicatively coupled to one or more cameras, one or more sensors, one or more IoT devices, or any other data producing communication device.

In one or more embodiments, CPU 100c can host a TEE that can store encrypted data associated with security camera 100a (security camera 100a can also be part of the TEE) into database 100i and provide the data to communication device 100f over communication network 100d at a later time (e.g., not in real-time). Further, the CPU 100c can authenticate the data for communication device 100f, as described herein. In addition, the server 100h can implement a remote attestation service that can facilitate the authentication of the data by the TEE for communication device 100f via a signing key resulting in signed data. Also, the CPU 100c can encrypt the signed data associated with security camera 100a, and store the encrypted signed data, then provide the encrypted signed data to communication device 100f over communication network 100d upon receiving a request, accordingly. Key vault 100e can be a storage device in which the CPU 100c can provide and store a decryption key to decrypt the encrypted signed data. Further, the communication device 100f can obtain the decryption key from the key vault 100e to decrypt the encrypted signed data accordingly.

One or more embodiments can include TEE (implemented by the data producer computing system 100b), which can be an enclave, a virtual machine, or a TEE-enabled sensor or camera 100a that generates data and stores the data in storage device 100i for later access by an outside party, such as user 100g utilizing communication device 100f. When consuming the data at a later time, the outside party may require proof of the generated data's provenance (e.g., authenticity).

One or more embodiments that implement authenticating data from a TEE include providing secure storage of the generated data (e.g., from security camera 100a), proof of provenance (e.g., authenticity) and non-repudiation, resiliency, upgradability, compatibility, and performance.

Securing storage of generated data can include generation of data decoupled from its subsequent consumption. To store data securely for later retrieval, the generated data can be either or both of: integrity-protected; and/or confidentiality-protected. The recipient of the data (e.g., user 100g utilizing communication device 100f) requires a mechanism to ensure that the generated data is authentic. Meaning that it is verifiably attested as having originated from a trustworthy TEE, the data has originated inside the right kind (per some external policy) of TEE and its associated Trusted Compute Base (TCB). TCB includes any peripheral devices used in processing this data, such as storage offload peripherals. Embodiments can contend with the integrity requirements to the originating TEE may have changed from the time when that TEE has executed to when its integrity is subsequently assessed (e.g., due to vulnerabilities being discovered and patched).

Further, proof of provenance and non-repudiation can include that the authenticity of data provided by a TEE is usually verified by having it produce a quote, a signature by the platform that may include an externally generated and unguessable freshness token (e.g., a nonce). Because the eventual recipient (e.g., user 100g via communication device 100f) is not necessarily available to receive the freshly generated data, or simply not yet known, it cannot be the source of the nonce to include in the quote, because remote attestation is delayed (e.g., provided at a time later than when the data was generated). The recipient (e.g., user 100g) can also stipulate that knowledge of the decryption key must not enable another recipient to generate its own spoofed data and attribute these to the originating TEE (a property that will be referred to herein as Strong Non-Repudiation or SNR).

Regarding resiliency, in embodiments that include generation of a potentially large stream of data, the embodiments accommodate instances in which the originating TEE suffers an outage, then needs to restart and resume generating data, appending the new data to the previously generated data. Referring to FIGS. 1 and 2, in some embodiments, the to survive a power outage to prevent the signing key or encryption key from being lost, the data producer 200a can obtain a random number from a random number generator, then sealing the key (e.g., signing key or encryption key) to the platform (e.g., camera 100a) in storage device 100i, accordingly. Further, CPU 100c can access the key (e.g., signing key, encryption key, etc.) from storage device 100i after recovering from the power outage, accordingly.

Regarding upgradability, in embodiments that include TEE outage, the implementation of the TEE can accommodate the possible upgrade of the originating TEE midway through data generation (e.g., the outage itself might have been caused by a buggy or outdated TEE that needed to be replaced midway by a more current one).

Regarding compatibility, embodiments include that the generated data is stored on any commonly deployed storage medium (e.g. storage device 100i). Storing of the generated data does not comprise any additional metadata that can be included alongside (but not in-band with) the generated data, unless the storage medium already supports such a feature.

Regarding performance, embodiments can handle generating large continuous streams of data, or, conversely, lots of small chunks of data, while minimizing the latency, processing and storage overheads compared with instances in which the same data are generated for immediate consumption. Conversely, neither can embodiments impose excessive performance penalties on the data's originator (producer) or recipient.

One or more embodiments of the TEE can be described as delayed multi-generational attestation with strong non-repudiation properties of the originating TEE in the context of intermediate untrusted data storage.

Referring to FIG. 2, in one or more embodiments, the system 200 can include a data producer 200a, which can be implemented by security camera 100a and CPU 100c. The data producer 200a can include generated data 200b (e.g., generated by security camera 100a) and cached keys 200c. Further, the data producer 200a can include a Data Encryption, Signing and Encoding (DESE) library 200d as well as a Key Provisioning, Export, Caching, and Certification (KPECC) library 200e. In addition, the system 200 can include data consumer 200j, which can be implemented by communication device 100f. The data consumer 200j can include the Key Import and Validation (KIV) library 2001 and the Data Decoding, Validation and Decryption (DDVD) library 200m as well as the received data 200k. Also, the system 200 can include the remote attestation service 200f, implemented by server 100h as well as the exported keys 200h and generated data 200i, provided by server 100h originating from within the TEE.

One or more embodiments include creation of a targeted mechanism for solving the authentication of generated data accessed at a later time, encapsulated in a set of reusable software libraries. The functions of some embodiments can include key provisioning and validation application programming interface (API) to handle key generation, caching, import, export, certification, and validation, to be used in a variety of scenarios depending on intent of administration personnel provisioning the TEE. The data producer 200a can implement these functions utilizing KPECC library 200c. The data consumer 200j can implement these functions utilizing the KIV library 2001. Further, the functions of additional embodiments that include data generation and consumption API to intermediate data writes and reads using this key material. The data producer 200a can implement these functions utilizing the DESE library 200d. In addition, the data consumer 200j can implement these functions utilizing the DDVD library.

In one or more embodiments, secure storage of data requires establishing some secret key material and having a mechanism for sharing it with authorized parties. In implementing confidentiality, the originating data producer 200a comes into possession of a symmetric encryption key for protecting the generated data against disclosure. This encryption key can either be generated by the data producer 200a or provided to the data producer 200a by an outside party (this embodiment can be preferred when multiple identical concurrently executing data producers (e.g., TEEs) are funneling their outputs into the same location). Further, the encryption key can be unsealed from a blob persisted by a previously running instance of the same TEE version. In addition, the encryption key can be made available to a trusted outside party via a secure export/import mechanism or directly from a centralized key store (e.g., key vault).

In one or more embodiments, when SNR is implemented, the originating data producer 200a also needs to come into possession of an asymmetric signing key for authenticating the generated data. Further, the signing key can be generated by the data producer 200a or provided to the data producer 200a by an outside party (this embodiment can be weaker since the data producer 200a is best positioned to safeguard the private signing key against leakage, but may still be preferred if multiple concurrently executing data producers are funneling their outputs into the same location). In addition, the signing key can be unsealed from a blob sealed by a previously running instance of the same TEE version associated with the data producer. Also, the signing key can be made available to a trusted outside party via a secure export/import mechanism, or directly from a centralized key store (e.g., key vault).

In one or more embodiments, the data producer 200a can seal freshly generated or imported encryption and signing keys to the platform to speed up subsequent restarts. Both encryption and signing keys can be sealed such that only the current version of the TEE associated with the data producer 200a can subsequently unseal them (failure to abide by this condition means that an older vulnerable version could access data generated by the subsequent fixed version (encryption) or impersonate it (signing)).

One or more embodiments can perform remote attestation and key storage. This function is performed when launching for the first time (or immediately following an upgrade), or whenever fresh keys are generated inside the data producer 200a. For SNR, the data producer 200a generates an asymmetric signing key SK and a nonce. The nonce can be the hash of SKpub or obtained from a designated external source (in which case a cryptographically signed timestamp can be used). The data producer 200a hashes the signing (SKpub) key in its possession, as well as the nonce, obtaining Q: =Quote (OWF (SKpub∥nonce)). In addition, certifying the signing key can be done by using one of the two following embodiments. Generation-time attestation includes using the generated Quote (e.g., as part of a Certificate Signing Request), the data producer 200a may then obtain from the remote attestation service a certificate around SKpub, which it can then be communicated to the recipient in any number of ways, including inside the data stream itself. Consumption-time attestation includes the data producer 200a making the Quote available to the eventual recipient of the data, whether in-band or out-of-band.

In one or more embodiments, the data producer 200a makes available to the eventual consumer the symmetric encryption key. Embodiments include the encryption key can be made available for confidential import into the correct target recipient, decided in accordance with an access control policy, which in turn may require that recipient to pass its own attestation, as a precondition to access. In other embodiments, the exported key can be stored in-band with the generated data stream. In further embodiments, the exported key can be stored in a key vault. In additional embodiments, it is also possible to export the symmetric key to a public key encryption key, include the exported key (in-band or out-of-band) with the data stream, and separately deliver the corresponding private key decryption key to the eventual recipient.

One or more embodiments include generating and storing attested data. Segments of data are generated by the data producer 200a. These data segments can be large, in case of, e.g., a surveillance camera, or small, in case of, e.g., a low-bandwidth IoT sensor. The generating TEE is free to buffer several consecutive segments of data into a contiguous block. How much buffering is allowed (from none to some cumulative time and/or storage limit), is subject to resiliency and latency requirements and can vary between applications, this can be a tunable parameter. These data segments are then signed (if in SNR is implemented), and/or encrypted (if data confidentiality is implemented). Also, using the hosting environment, the data segments are flushed out and stored in an append-only fashion to the target storage medium. Further, the buffering, signing, encrypting, and storing of the data segments can be performed by a trusted and separately attested confidential peripheral, offloading the main computer processing unit (CPU) of the data producer 200a.

In one or more embodiments, in the beginning of the generated stream, generated after the data producer 200a first comes into possession of a fresh signing key, includes a segment containing the quoted (or certified) signing key. The alternative is for the generating data producer 200a to store that quote or certificate elsewhere, where the recipient can later access it. Subsequent data segments need not include this information, unless the signing key changes mid-stream, in which case updated key identifying information can be included in-band.

In one or more embodiments, the data consumer 200j can perform retrieve and process the data including perform key retrieval and remote attestation. The data consumer 200j needs to either discover, or be notified, where to obtain the symmetric encryption and public signing keys. These could be retrieved by the data consumer 200j, subject to policy, from a key vault or another data store, or be encoded (in-band or out-of-band) with the generated data stream itself. Possession of the keys include possession of their associated metadata. The encryption key has been obtained, and trust in it is verified by its ability to decrypt the encrypted data stream. The signing key may either come certified (accompanied by a certificate issued by a trusted attestation service or certification authority), or quoted (requiring the data consumer to contact a remote attestation service in order to establish trust in the signing key).

One or more embodiments can perform attestation of the generating data producer 200a. Some embodiments implement generator-side attestation. This includes a single attestation service. In some embodiments, the attesting party (the data producer's hosting environment) generates the quote over the key(s) it holds and then contacts the remote attestation service with that quote. The quote serves as the evidence for a certificate service request (CSR) to a trusted CA, which may be co-located with the remote attestation service. The issued certificate is then associated with the generated data stream, and its time of issuance serves as proof that the data producer 200a has satisfied the then-current attestation service policies. A single certificate may serve to prove provenance of multiple independent data streams emanating from the same data producer. When choosing to sign multiple streams, one must be careful to consider whether the generating data producer has privacy concerns stemming from all the generated data pointing to the same originator. Certain embodiments may include that the data producer remains up to date with security patches as remote attestation service policies evolve. This may necessitate periodic remote re-attestation of the generating data producer, and issuance of updated certificates at specified time intervals, or in response to an external event, such as a TEE upgrade associated with the data producer 200a.

Other embodiments can implement consumption-side attestation. The data consumer uses the signing key quote furnished by the generating data producer 200a to assess the data producer's trustworthiness. In such embodiments, the originating data producer can also prove that it was up to date at the time of data generation, which would require it to obtain a fresh nonce (a securely signed timestamp can suffice), which can be sufficiently unknowable. When decoding the generated stream, the data consumer can validate the received quote against a trusted attestation service, by giving it the quote, as well as validate the nonce value against its issuer's signing key (that latter function may also be performed by the remote attestation service).

One or more embodiments can include minimizing downtime due to upgrades. In one embodiment, it may arise where a version N of a TEE associated with a data producer 200a is executing and actively generating data, where it needs to be upgraded to version N+1 as fast as possible, to minimize downtime. This can be accomplished by structuring the TEE code to launch in one of two modes: “provisioning” and “execution”. The implementation packages both code paths into the same module, so that the TEE-held encryption and signing keys can be sealed to that particular code image (otherwise, separate provisioning and execution enclaves can be created). Once the provisioning is completed, version-N TEE can be shut down and version-N+1 TEE can be quickly brought up and resume operation, by unsealing pre-provisioned keys.

One or more embodiments can include the choice of signing and encryption algorithms, as well as the choice of key sizes, paddings and modes, can be tunable parameters. A digital signature algorithm can include fast signing (leading to faster data generation time), fast verification (leading to faster data consumption time), small signature size (to decrease the output stream size), capable of generating and/or validating multiple signatures efficiently, and/or have an efficient and side-channel-proof hardware implementation. Other aspects of the digital signature algorithm can include minimizing key generation time, minimizing key size, since larger keys yield better security and key sizes are not an appreciable percentage of the generated streamed data volume, avoid padding attacks. An encryption algorithm can include any symmetric block cipher such Advanced Encryption Standard-Cipher Block Chaining (AES-CBC) or Advanced Encryption Standard with Galois Counter Mode (AES-GCM), with the GCM (authenticated encryption) mode strongly preferred when not implementing SNR.

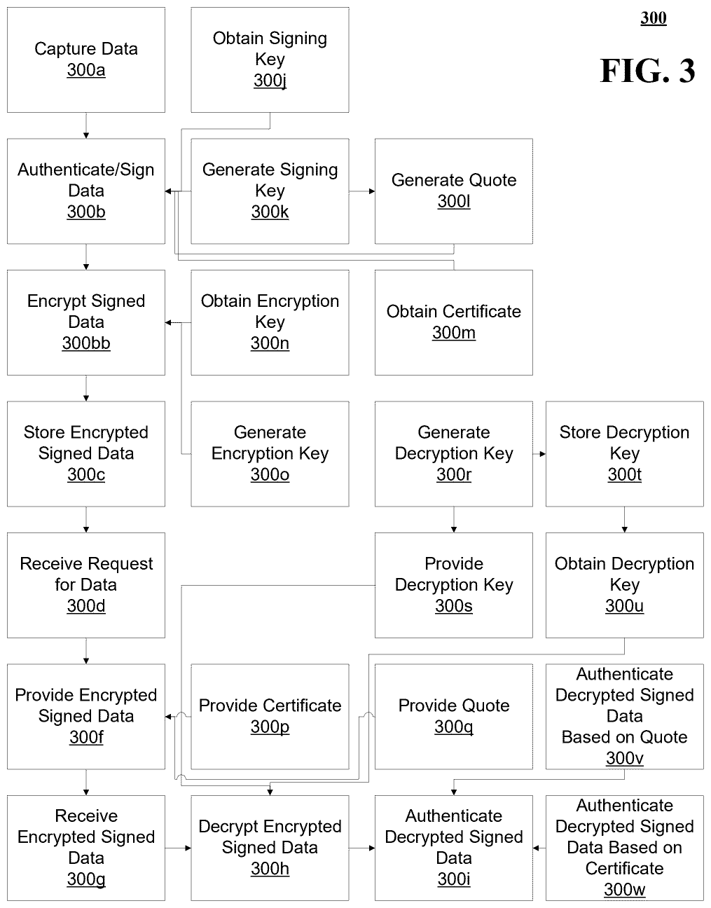

FIG. 3 depicts an illustrative embodiment of a method 300 in accordance with various aspects described herein. Aspects of method 300 can be implemented by a processing system including a processor (e.g., CPU) and/or a communication device as part of a TEE. Method 300 can include a processing system, at 300a, capturing data from a first communication device associated with a data producer. The first communication device can include a camera, sensor, IoT device, or any other data producing communication device. Further, the method 300 can include a processing system, at 300b, signing the data with a signing key resulting in signed data. The authentication of the data verifies the provenance data with SNR, as described herein. Further, the method 300 can include a processing system, at 300bb, encrypting the signed data according to an encryption key resulting in encrypted signed data. In addition, the method 300 can include a processing system, at 300c, storing the encrypted data in a storage device.

In one or more embodiments, the method 300 can include a processing system, at 300d, receiving, over a communication network, a request associated with the data from a second communication device associated with a data consumer. In addition, the method 300 can include a processing system, at 300f, providing, over the communication network, the encrypted signed data to the second communication device.

In one or more embodiments, the method 300 can include the second communication device, at 300g, receiving the signed encrypted data. Further, the method 300 can include the second communication device, at 300h, decrypting the encrypted signed data according to a decryption key resulting in the decrypted signed data. In addition, the method 300 can include the second communication device, at 300i, authenticating the decrypted signed data to verify its provenance.

In one or more embodiments, the method 300 can include the processing system, at 300j, obtaining the signing key. Further, the method 300 can include the processing system, at 300k, generating the signing key. In some embodiments, the obtaining of the signing key can comprise generating the signing key. In other embodiments, obtaining of the signing key can comprise obtaining the signing key from a third-party communication device.

In one or more embodiments, the method 300 can include the processing system, at 300n, obtaining the encryption key. Further, the method 300 can include the processing system, at 3000, generating the encryption key. In some embodiments, the obtaining of the encryption key can comprise generating the encryption key. In other embodiments, obtaining of the encryption key can comprise obtaining the encryption key from a third-party communication device.

In one or more embodiments, the method 300 can include the processing system, at 300l, generating a quote based on the signing key and a nonce. In some embodiments, the authenticating of the data with the signing key comprises generating a quote based on the signing key and a nonce. Further, the method 300 can include the processing system, at 300m, obtaining a certificate from a remote attestation service based on the quote. In some embodiments, the authenticating of the data with the signing key comprises obtaining a certificate from the remote attestation service based on the quote.

In one or more embodiments, the method 300 can include the processing system, at 300q, providing, over the communication network, the quote to the second communication device. In some embodiments, the providing of the encrypted signed data comprises providing, over the communication network, the quote to the second communication device. Further, the method 300 can comprise the second communication device, at 300v, authenticating the data based on the quote. In some embodiments, the second communication device authenticating the decrypted signed data comprises the second communication device authenticating the data based on the quote.

In one or more embodiments, the method 300 can include the processing system, at 300p, providing, over the communication network, the certificate to the second communication device. In some embodiments, the providing of the encrypted signed data by the server comprises providing, over the communication network, the certificate to the second communication device. Further, the method 300 can include the second communication device, at 300w, authenticating the data based on the certificate. In some embodiments, the second communication device authenticating the decrypted signed data comprises the second communication device authenticating the data based on the certificate.

In one or more embodiments, the method 300 can include the processing system, at 300r, generating the decryption key. Further, the method 300 can include the processing system, at 300t, storing the decryption key in a key vault. In addition, the method 300 can include the second communication device, at 300u, obtaining the decryption key from the key vault. In further embodiments, the method 300 can include the processing system, at 300s, providing, over the communication network, the decryption key to the second communication device.

While for purposes of simplicity of explanation, the respective processes are shown and described as a series of blocks in FIG. 3, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. Note, one or more blocks can be performed in response to one or more other blocks.

Further, some portions of embodiments can be combined with portions of other embodiments.

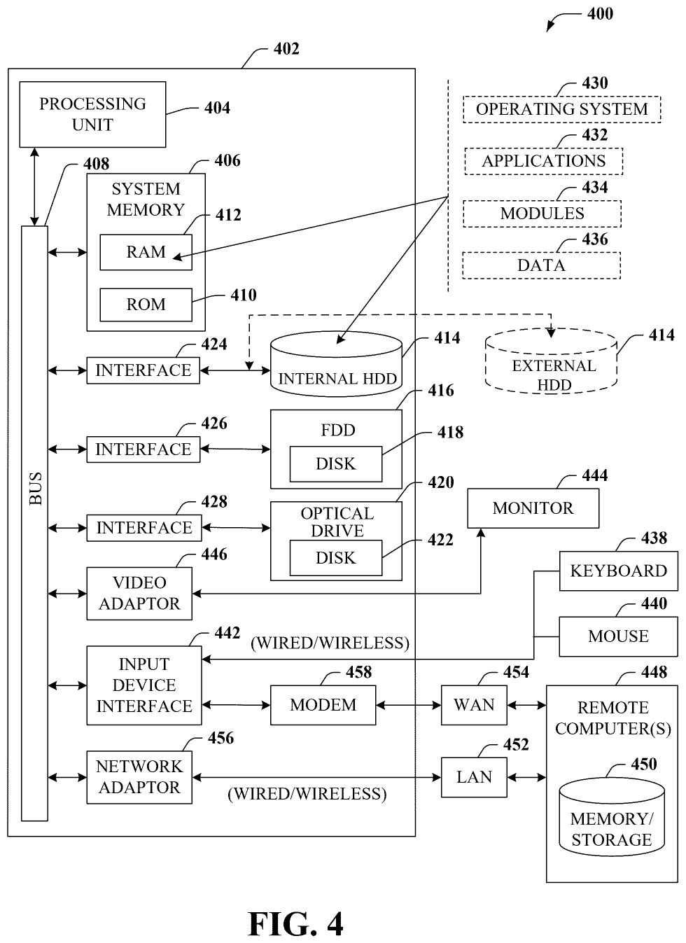

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, the computing environment 400 can be used in computing device described herein. Each of these devices can be implemented via computer-executable instructions that can run on one or more computers, and/or in combination with other program modules and/or as a combination of hardware and software. For example, computing environment 400 can facilitate in whole or in part authenticating data for later access from a TEE. Further, each of security camera 100a, CPU 100c, data producer computer system 100b, key vault 100e, communication device 100f, server 100h, and storage device 100i can comprise a computing environment 400.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

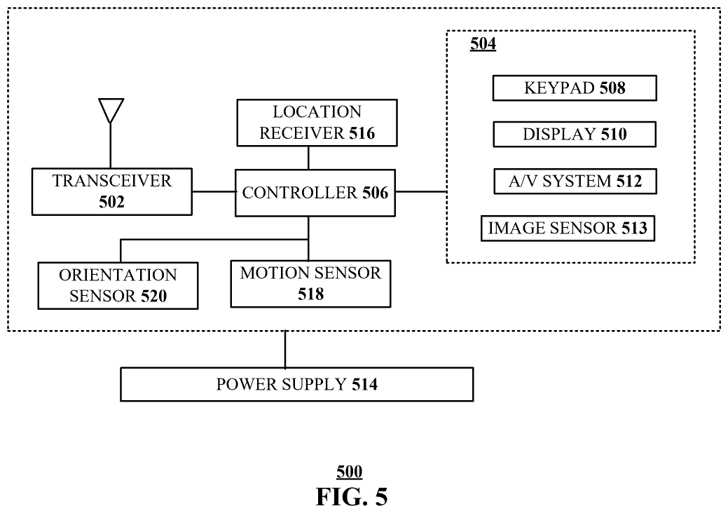

Turning now to FIG. 5, an illustrative embodiment of a communication device 500 is shown. Communication device 500 can facilitate in whole or in part authenticating data for later access from a TEE. Further, each of security camera 100a, data producer computer system 100b, CPU 100c, key vault 100e, communication device 100f, server 100h, and storage device 100i can comprise a communication device 500.

The communication device 500 can comprise a wireline and/or wireless transceiver 502 (herein transceiver 502), a user interface (UI) 504, a power supply 514, a location receiver 516, a motion sensor 518, an orientation sensor 520, and a controller 506 for managing operations thereof. The transceiver 502 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 502 can also be adapted to support circuit-switched wireline access technologies (such as PSTN), packet-switched wireline access technologies (such as TCP/IP, VOIP, etc.), and combinations thereof.

The UI 504 can include a depressible or touch-sensitive keypad 508 with a navigation mechanism such as a roller ball, a joystick, a mouse, or a navigation disk for manipulating operations of the communication device 500. The keypad 508 can be an integral part of a housing assembly of the communication device 500 or an independent device operably coupled thereto by a tethered wireline interface (such as a USB cable) or a wireless interface supporting for example Bluetooth®. The keypad 508 can represent a numeric keypad commonly used by phones, and/or a QWERTY keypad with alphanumeric keys. The UI 504 can further include a display 510 such as monochrome or color LCD (Liquid Crystal Display), OLED (Organic Light Emitting Diode) or other suitable display technology for conveying images to an end user of the communication device 500. In an embodiment where the display 510 is touch-sensitive, a portion or all of the keypad 508 can be presented by way of the display 510 with navigation features.

The display 510 can use touch screen technology to also serve as a user interface for detecting user input. As a touch screen display, the communication device 500 can be adapted to present a user interface having graphical user interface (GUI) elements that can be selected by a user with a touch of a finger. The display 510 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 510 can be an integral part of the housing assembly of the communication device 500 or an independent device communicatively coupled thereto by a tethered wireline interface (such as a cable) or a wireless interface.

The UI 504 can also include an audio system 512 that utilizes audio technology for conveying low volume audio (such as audio heard in proximity of a human car) and high-volume audio (such as speakerphone for hands free operation). The audio system 512 can further include a microphone for receiving audible signals of an end user. The audio system 512 can also be used for voice recognition applications. The UI 504 can further include an image sensor 513 such as a charged coupled device (CCD) camera for capturing still or moving images.

The power supply 514 can utilize common power management technologies such as replaceable and rechargeable batteries, supply regulation technologies, and/or charging system technologies for supplying energy to the components of the communication device 500 to facilitate long-range or short-range portable communications. Alternatively, or in combination, the charging system can utilize external power sources such as DC power supplied over a physical interface such as a USB port or other suitable tethering technologies.

The location receiver 516 can utilize location technology such as a global positioning system (GPS) receiver capable of assisted GPS for identifying a location of the communication device 500 based on signals generated by a constellation of GPS satellites, which can be used for facilitating location services such as navigation. The motion sensor 518 can utilize motion sensing technology such as an accelerometer, a gyroscope, or other suitable motion sensing technology to detect motion of the communication device 500 in three-dimensional space. The orientation sensor 520 can utilize orientation sensing technology such as a magnetometer to detect the orientation of the communication device 500 (north, south, west, and cast, as well as combined orientations in degrees, minutes, or other suitable orientation metrics).

The communication device 500 can use the transceiver 502 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 506 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 500.

Other components not shown in FIG. 5 can be used in one or more embodiments of the subject disclosure. For instance, the communication device 500 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f (x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A system, comprising:
a processing system including a processor; and
a memory that stores executable instructions that, when executed by the processing system, facilitate performance of operations comprising:
capturing data by a first communication device associated with a data producer;
signing the data with a signing key resulting in signed data;
encrypting the signed data according to an encryption key resulting in encrypted signed data;
storing the encrypted data in a storage device;
receiving, over a communication network, a request associated with the data from a second communication device associated with a data consumer; and
providing, over the communication network, the encrypted signed data to the second communication device, wherein the second communication device receives the encrypted signed data, wherein the second communication device decrypts the encrypted signed data according to a decryption key resulting in decrypted signed data, wherein the second communication device authenticates the decrypted signed data.

2. The system of claim 1, wherein the operations comprise obtaining the signing key.

3. The system of claim 2, wherein the obtaining of the signing key comprises generating the signing key.

4. The system of claim 2, wherein the obtaining of the signing key comprises obtaining the signing from a third-party communication device.

5. The system of claim 1, wherein the operations comprise obtaining the encryption key.

6. The system of claim 5, wherein the obtaining of the encryption key comprises generating the encryption key.

7. The system of claim 5, wherein the obtaining of the encryption key comprises obtaining the encryption key from a third-party communication device.

8. The system of claim 1, wherein the authenticating of the data with the signing key comprises generating a quote based on the signing key and a nonce.

9. The system of claim 8, wherein the providing of the encrypted signed data comprises providing, over the communication network, the quote to the second communication device, wherein the second communication device authenticating the signed data comprises the second communication device authenticating the decrypted signed data based on the quote.

10. The system of claim 8, wherein the authenticating of the data with the signing key comprises obtaining a certificate from a remote attestation service based on the quote.

11. The system of claim 10, wherein providing of the encrypted signed data comprises providing, over the communication network, the certificate to the second communication device, wherein the second communication device authenticating the decrypted signed data comprises the second communication device authenticating the decrypted signed data based on the certificate.

12. The system of claim 1, wherein the operations comprise storing the decryption key in a key vault, wherein the second communication device obtains the decryption key from the key vault.

13. The system of claim 1, wherein the operations comprise providing, over the communication network, the decryption key to the second communication device.

14. A non-transitory machine-readable medium, comprising executable instructions that, when executed by a client computing device including a processing system including a processor, facilitate performance of operations, the operations comprising:
capturing data by a first communication device associated with a data producer;
obtaining a signing key;
signing the data with the signing key resulting in signed data;
obtaining an encryption key;
encrypting the signed data according to the encryption key resulting in encrypted signed data;
storing the encrypted data in a storage device;
receiving, over a communication network, a request associated with the data from a second communication device associated with a data consumer; and
providing, over the communication network, the encrypted signed data to the second communication device, wherein the second communication device receives the encrypted signed data, wherein the second communication device decrypts the encrypted signed data according to a decryption key resulting in decrypted signed data, wherein the second communication device authenticates the decrypted signed data.

15. The non-transitory machine-readable medium of claim 14, wherein the obtaining of the signing key comprises generating the signing key.

16. The non-transitory machine-readable medium of claim 14, wherein the obtaining of the signing key comprises obtaining the signing from a third-party communication device.

17. The non-transitory machine-readable medium of claim 14, wherein the obtaining of the encryption key comprises generating the encryption key.

18. The non-transitory machine-readable medium of claim 14, wherein the obtaining of the encryption key comprises obtaining the encryption key from a third-party communication device.

19. A method, comprising:
capturing, by a processing system including a processor, data by a first communication device associated with a data producer;
generating, by the processing system, a signing key;
signing, by the processing system, the data with the signing key resulting in signed data;
generating, by the processing system, an encryption key;
encrypting, by the processing system, the signed data according to the encryption key resulting in encrypted signed data;
storing, by the processing system, the encrypted data in a storage device;
receiving, by the processing system, over a communication network, a request associated with the data from a second communication device associated with a data consumer;
providing, by the processing system, over the communication network, the encrypted signed data to the second communication device, wherein the second communication device receives the encrypted signed data, wherein the second communication device decrypts the encrypted signed data according to a decryption key resulting in decrypted signed data, wherein the second communication device authenticates the decrypted signed data.

20. The method of claim 19, wherein authenticating of the data with the signing key comprises generating a quote based on the signing key and a nonce, wherein providing of the encrypted signed data comprises providing, over the communication network, the quote to the second communication device, wherein the second communication device authenticating the decrypted signed data comprises the second communication device authenticating the decrypted signed data based on the quote.
